(19) United States
(12) Patent Application Publication
(10) Pub. No.: US 2018/0167597 A1
(43) Pub. Date: Jun. 14, 2018

(54) METHODS, APPARATUS, AND SYSTEMS FOR HDR TONE MAPPING OPERATOR

(71) Applicant: THOMSON Licensing, Issy-les-Moulineaux (FR)

(72) Inventors: Mozhdeh SEIFI, Thorigne-Fouillard (FR); Mehmet TURKAN, RENNES (FR); Erik REINHARD, Hédé-Bazouges (FR)

(21) Appl. No.: 15/577,830

(22) PCT Filed: May 11, 2016
(86) PCT No.: PCT/EP2016/060548

§ 371 Date: Nov. 29, 2017

(30) Foreign Application Priority Data
May 29, 2015 (EP) 15305828.4

(51) Int. Cl. H04N 9/77; H04N 11/20; H04N 17/02; G06T 5/00

(52) U.S. Cl. CPC H04N 9/77; H04N 11/20; G06T 2207/20208; G06T 5/009; H04N 17/02

(57) ABSTRACT

Aspects of present principles are directed to methods and apparatus for tone mapping a high dynamic range image. The apparatus includes a processor for performing the following and the method includes the following: obtaining a luminance component of the high dynamic range image; determining an hdr-to-hdr tone mapper curve; determining a tone compressed image by applying the hdr-to-hdr tone mapper curve to the luminance component of the high dynamic range image; wherein the hdr-to-hdr tone mapper curve comprises a linear part for dark and mid-tone levels, and a compressive non-linear part for highlights.

### TECHNICAL FIELD

The present disclosure relates to image and video processing. In particular, the present disclosure relates to conversion of image or video data utilizing an HDR tone mapping operator.

### BACKGROUND

Light in nature covers an enormous range of luminance levels, from starlight to bright sunlight. Yet traditional imaging technologies, both digital and analog, offer diminished experience because they cannot parallel the wide range of luminance and contrast that is visible to our eyes. In response, High Dynamic Range (“HDR”) technologies are being developed to allow an extended range of color, luminance and contrast to be displayed.

HDR technologies focus on capturing, processing and displaying content of a wider dynamic range. Although there are in development HDR displays and cameras to capture HDR content, the HDR content need to undergo tone mapping for legacy displays to be able to reproduce the content.

Tone reproduction, also known as tone mapping, aims to map an image's original range of luminance values to a lower range of luminance values that can be reproduced by a legacy display. Often, but not always, tone mapping is carried out on a luminance channel that is derived from the original color image. The output of the tone mapping can be recombined with the color information retained from the original image, so that a new color image is produced with a dynamic range lower than the input image.

Tone mapping algorithms can be classified into two broad classes. A first class can be defined as global tone mapping. This involves applying compressive function(s) (e.g., sigmoidal functions or logarithmic functions) independently to the luminance values of each pixel of the image or image sequence

A second class can be defined as local tone mapping (also known as spatially varying tone mapping). Local tone mapping takes into account, for each pixel, the luminance value of that pixel, as well as information from its neighboring pixels. For example, a light pixel embedded in a cluster of light pixels will be treated differently from the same light pixel surrounded by a cluster of dark pixels. Thus, in the local tone mapping case, the comprehensive function of the global tone mapping case is modulated by each pixel's environment. This has several consequences:
The computational cost of global tone mapping tends to be much lower than for local tone mapping.
The visual quality of local tone mapping can be higher than that achieved with global tone mapping.
The probability of introducing unwanted visual artefacts is higher in local tone mapping than for global tone mapping. This is often seen as (dark) halos in images.

The intended use case for known tone mapping operators is to reduce the range of luminance values by a very large amount. The difference between light levels of luminance observed in the real world and the intended output (normally around 100 nits) is very significant, forcing the design of appropriate tone mapping operators to make trade-offs between visual quality and computational complexity. For example, existing tone mapping operators compress full luminance channel information (e.g., maximum 4000 nits content) to fit into the very low range of the legacy, non-HDR displays (e.g., 100 nits content). In some cases, however, the tone mapper is required to reduce the range by a significantly smaller factor, e.g., from maximum 4000 nits to 1500 nits (e.g., for range compression between different HDR displays). However, classical tone mapping operators fail to fully reproduce the HDR sensation because they compress the whole range of luminance and rescale linearly luminance values to fit into the target display range. This means that the relative luminance of the neighboring pixels follows a sensation of LDR content.

The following articles illustrate some examples of tone mapping:
“Optimized tone mapping with perceptually uniform luminance values for backward-compatible high dynamic range video compression”, by Alper Koz and Frederic Dufaux,
“Regionally optimized image contrast enhancement”, by Wataru Okado et al., in 3rd Global Conference on Consumer Electronics (GCCE), IEEE, 2014.

In view of these problems, there is a need for a solution that improves the visual quality of luminance reproduction on displays that have a high peak luminance, albeit that this peak luminance is lower than the peak luminance of the content it may receive.

### SUMMARY OF PRESENT PRINCIPLES

There is thus a need to improve the visual quality of high dynamic range content on displays with a peak luminance below the peak luminance of the content, where the peak luminance of the display is assumed to be high (for instance above 500 cd/m²).

Aspects of present principles are directed to methods and apparatus for tone mapping a high dynamic range image. The apparatus includes a processor configured to perform the following and the method comprises the following: obtaining a luminance component of the high dynamic range image; determining an hdr-to-hdr tone mapper curve; determining a tone compressed image by applying the hdr-to-hdr tone mapper curve to the luminance component of the high dynamic range image; wherein the hdr-to-hdr tone mapper curve comprises a linear part for dark and mid-tone levels, and a compressive non-linear part for highlights.

The method or apparatus are configured wherein the hdr-to-hdr tone mapper includes a threshold for determining when the luminance is changed linearly and when the luminance is compressed non-linearly. The method or apparatus are configured wherein a final threshold if is determined based on an initial threshold τ according to the following equation:

$${τ}_{f} = \{ \begin{matrix}τ & ρ \leq n \\ \frac{{I}_{o}^{max}}{α - n} ( α - ρ ) & n < ρ \leq α \\ 0 & ρ > α\end{matrix}$$

It means that an initial threshold τ may be modified if the percentage of pixels in the image with a value larger than τ passes certain criteria. The benefit of this modification is that if the image is overall very bright, then the compression algorithm is adjusted to account for this. This improvement creates advantageously a tone reproduction operator with an improved visual appearance.

The method or apparatus further comprise determining the threshold based on content of the high dynamic range image to tone map. The method or apparatus are configured further comprise criteria to enforce continuity and smoothness of the hdr-to-hdr tone-mapper curve. This will help to avoid artefacts in tone-mapped images. For instance, this will avoid an image with a smooth gradient to become non-smooth after tone-mapping, even if there were a kink in the tone-mapping curve.

The method or apparatus further comprise wherein the high dynamic range image is part of a high dynamic range video, and wherein the application of the hdr-to-hdr tone mapper curve includes applying information from prior video frames to achieve temporal stability. The method or apparatus are configured wherein the information from prior video frames is applied using leaky integration based on the threshold.

The method or apparatus further comprise signaling information representative of the hdr-to-hdr tone mapper curve. The method or apparatus are configured wherein signaling is performed using at least one syntax element included in at least one of a Picture Parameter Set (PPS), a Sequence Parameter Set (SPS), a Supplemental Enhancement Information (SEI) message, a Video Usability Information (VUI), Consumer Electronics Association (CEA) message, and a header. The method or apparatus are configured wherein parameters of the hdr-to-hdr tone mapper curve are modulated as a function of the threshold, and wherein the parameters are modulated at least one selected from a group of linearly and non-linearly.

An aspect of present principles is directed to a method and apparatus for tone mapping a high dynamic range image, the method comprising obtaining a luminance component of the high dynamic range image; determining an hdr-to-hdr tone mapper curve; determining a tone compressed image by applying the hdr-to-hdr tone mapper curve to the luminance component of the high dynamic range image; wherein the hdr-to-hdr tone mapper curve is multi-segmented, and wherein the multi-segmented curve includes at least a segment that is not linear and at least a segment that is linear. The method and apparatus are further configured wherein the linear segment is directed to at least one selected from a group of darks, mid-tones, and highlights, and wherein the non-linear segment is directed to at least one selected from a group of darks, mid-tones, and highlights.

### BRIEF SUMMARY OF THE DRAWINGS

The features and advantages of the present invention may be apparent from the detailed description below when taken in conjunction with the Figures described below:

FIG. 1 is a diagram depicting an exemplary method of encoding a picture in accordance with present principles.

FIG. 2 is a diagram depicting an exemplary method of encoding a picture and parameters in accordance with present principles.

FIG. 3 is a diagram depicting an exemplary method for determining and encoding the parameters for the tone mapper.

FIG. 4 is a diagram depicting an exemplary method for decoding a picture or video in accordance with present principles.

FIG. 5 is a diagram depicting an exemplary apparatus in accordance with present principles.

FIG. 6 is a diagram depicting an exemplary plot in accordance with present principles.

FIG. 7 is a diagram depicting an exemplary plot in accordance with present principles.

FIG. 8 is a diagram depicting an exemplary plot in accordance with present principles.

### DETAILED DESCRIPTION

The present principles are directed to methods, apparatuses and systems for HDR to HDR tone mapping.

An aspect of present principles addresses the problem of diminishing quality of dynamic range of HDR content when converted to a target display. An aspect of present principles relates to reproducing the HDR sensation despite the compression to fit into the target display range.

An aspect of present principles relates to methods, apparatuses and systems for maintaining the HDR content similar to the source, while compressing the content only for very high ranges of information. This allows having the sensation of viewing HDR content, although on lower dynamic range displays. It also enables maintaining a director's intent. For instance, content graded on a 4000 nit reference display would be reproduced with good quality for display on a 1000 or 1500 nit consumer display.

The tone mapping operator in accordance of present principles may be utilized in a variety of applications. For example, the tone mapping operator may be utilized in a post-production studio, to aid in the regrading process to produce a secondary grade with a lower peak luminance. Alternatively, on the consumer side, an HDR-to-HDR tone mapping operator could be incorporated into an HDR consumer display or could be integrated into a set-top box.

An aspect of present principles relates to changing the dark and mid-tone levels linearly (or not change if possible), so that the intent of the photographer is kept as unchanged as possible. The proposed tone mapper acts on the luminance channel, and the chromatic information is corrected secondarily.

An aspect of present principles relates to determining a threshold τ for the luminance channel. The input for the luminance channel is then changed linearly for values under the threshold and changed non-linearly for values above the threshold. This linear change of value comes in the form of a scaling factors that is set most of the times to s=1, therefore keeping the input unchanged for the corresponding range of the luminance values.

An aspect of present principles relates to compressing very high luminance values (values bigger than threshold τ) using a variation of a tone mapper, (e.g., the photographic operator). The overall HDR-2-HDR tone mapper is designed to have a continuous curve, with smooth profile transition around the threshold value T.

An aspect of present principles relates to a preliminary color transformation that determines the luminance channel information from input RBG values. An aspect of present principles further relates to determining the design for a tone-mapper by introducing the conditions on the tone mapping curve. An aspect of present principles relates to determining the threshold τ from the content itself.

Preliminary Color Transformation

An aspect of present principles relates to determining luminance information for each pixel based on a transformation of the received content. In one example, the received content may be in a standard RGB color space. In one example, if the content is given in the sRGB color space, the calculation of a luminance value for pixel I is given by:

Iⁱ=0.2126×Rⁱ+0.7152×Gⁱ+0.0722×Bⁱ Equation No. 1:

Luminance values can be derived from other RGB color spaces in a similar manner, albeit that the constants in Equation No. 1 will be different. This is dependent on the definition of each individual RGB color space. Example RGB color spaces are ISO RGB, Extended ISO RGB, scRGB, Adobe RGB 98, Adobe Wide Gamut RGB, Apple RGB, ROMM RGB, ProPhoto RGB, CIE (1931) RGB, as well as RGB spaces defined in standards ITU-R Rec. BT 709, ITU-R Rec. BT 2020, ITU-R Rec. BT 470, SMPTE RP 145, and SMPTE 170M.

Alternatively, the luminance channel of any appropriate color space, such as Yuv, Yu′v′, YCbCr, YPbPr, Y′DbDr, Y′CC, CIE Yxy, CIE Lab, CIE Luv, CIE LCh, IPT, Y′I′Q′, EBU Y′U′V′ may be utilized instead. In this case, the image is transformed into such a color space, processing is applied to the luminance channel, and afterward a further color space transform may convert the image to a destination color space (which in one example may be an RGB color space).

Tone Mapper Variation

An aspect of present principles relates to a variation of a tone mapping algorithm to compress the luminance values based on a determination that the luminance values are greater (or not smaller than) a fixed threshold. In one example, the threshold may be determined using a slider in a GUI or can be automatically estimated.

In one example, a C1 tone-mapping function is designed for the full range of the input luminance. As used herein, a “C1” function is defined as a function with its first derivative being defined and continuous everywhere in the open interval of the input of the derivative function domain. In other words, the smoothness criterion is not defined at I=0 and I=I^{max}.

In one example, the maximum luminance value of the input content is I^{max} and the maximum producible luminance value by the output display is Iₒ^{max} In one example, the values for these variables are I^{max}=4000 nits and Iₒ^{max}=1500 nits.

In one example, the desired input tone-mapper function is [symbol] (I). In one example, the desired tone mapper function is set to the photographic operator

$$( I ) = \frac{I}{I + 1} .$$

An aspect of present principles is directed to a tone-mapper [symbol] _{new} (I, τ) that scales the input values smaller than τ by factor s (frequently s=1), and compresses non-linearly the values bigger than τ according to a variation of the function [symbol] . In one example, the tone-mapper is defined as follows:

$${new}_{} ( I , τ ) = \{ \begin{matrix}s I & if I \leq τ \\ \frac{a ( I - τ ) + c}{( I - τ ) + d} & otherwise\end{matrix} \qquad Equation No . 2$$

The three parameters a, c, d need to be set to satisfy the following three conditions to obtain a C1 tone-mapper [symbol] _{new} (I, τ)
i. The maximum input I^{max} should map to the maximum output Iₒ^{max}, therefore

[symbol]

_{new}(I^{max},τ)=Iₒ^{max} Equation No. 3:
ii. At I=τ, the tone-mapper needs to be continuous, therefore

[symbol]

_{new}(τ,τ)=Sτ Equation No. 4:
iii. Also, at I=τ, the gradient of the tone-mapper needs to be continuous, therefore,

$$\frac{\partial {new}_{}}{\partial I} ( τ , τ ) = s \qquad Equation No . 5$$

Solving this system of three equations for the three unknowns, a, c, d, results into the following:

$$\begin{matrix}d = \frac{( {I}^{max} - τ ) \times ( s τ - {I}_{o}^{max} )}{{I}_{o}^{max} - s {I}^{max}} & Equation No . 6 \\ c = s τ d & Equation No . 7 \\ a = \frac{{I}_{o}^{max} ( {I}^{max} - τ + d ) - c}{{I}^{max} - τ} & Equation No . 8\end{matrix}$$

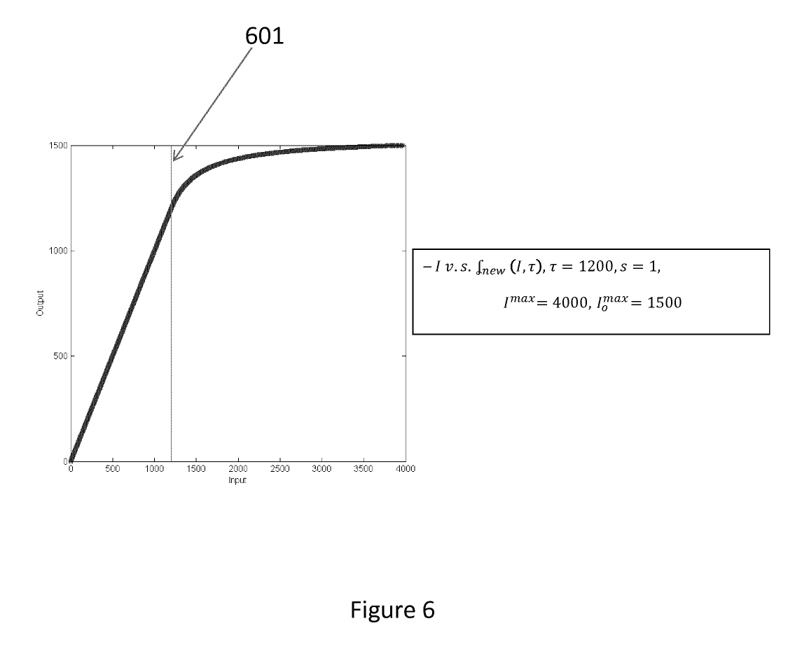

FIG. 6 illustrates a plot of I versus [symbol] _{new} (I, τ). The plot curve of FIG. 6 is determined for=1200, s=1, I^{max}=4000, Iₒ^{max}=1500. The threshold τ is marked by line 601 in FIG. 6. This plot shows the overall behavior of the tone mapper, i.e., linear in dark and mid-tone levels, and compressive non-linear in the highlights. It can be easily verified that the curve is indeed a C1 function. As used herein, a “C1” function is defined as a function with its first derivative being defined and continuous everywhere in the open interval of the input of the derivative function domain.

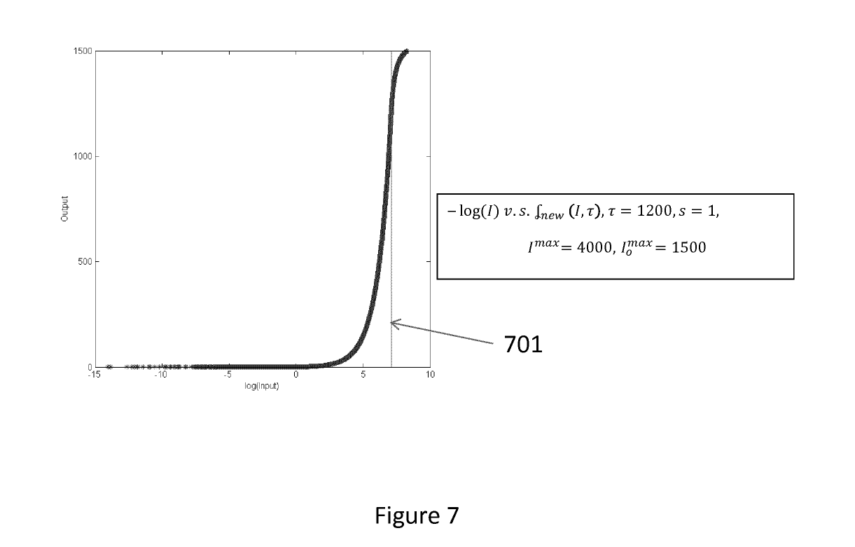

FIG. 7 illustrates a plot for log(I) versus [symbol] _{new} (I, τ). The threshold τ is marked by line 701 in FIG. 7. This curve shows the tone-mapper in logarithmic space and is provided only for the sake of comparison with state-of-art tone-mappers that are mostly performing in the logarithmic space.

The plots shown in FIGS. 6 and 7 illustrate the behavior of the tone mapper, i.e., linear in dark and mid-tone levels, and compressive non-linear in the highlights.

In another example, the methodology described above in connection with Equation Nos. 2 may be implemented through a Look-Up-Table with the sampled input values and output values for real-time tone-mapping.

Treatment of Low Luminance Values

The method described in Equations 2 to 8 describes a tone mapping approach with a linear segment for the dark parts and the mid-tones for an image. The lightest parts (for instance the highlights) are compressed with a non-linear function. A cross-over point determines the maximum value in the input which is passed through the linear part of the function, and the smallest value of the input which is passed through the non-linear part of the function.

In accordance with present principles, it may be advantageous to introduce a second cross-over point, separating the darkest part of the image (the blacks) from the remainder of the image. The blacks can then also be treated in a non-linear manner, for instance to account for the use-case where the black-level of the target display device is higher or lower than the black level of the content (or similarly, the black level of the grading monitor that was used to create the content).

Treatment of the Tone-Mapping Curve Parameters

The method described in Equations 2 to 8 describes a tone mapping approach with a linear segment for the dark parts and the mid-tones for an image. The lightest parts (for instance the highlights) are compressed with a non-linear function that is described by a parametric function. A cross-over point determines the maximum value in the input which is passed through the linear part of the function, and the smallest value of the input which is passed through the non-linear part of the function.

In accordance with present principles, it may be advantageous to modulate the curve parameters in accordance with the cross-over point. This modulation can be linear or non-linear. In one example, this modulation makes the parameters of Equation Nos. 2 to converge to defined values. In one example, it is desired for a and d to converge to 1, and for c to converge to 0, when the cross-over point converges to 0. In this case, [symbol] _{new} (I, τ) converges to [symbol] (I) when the cross-over point converges to 0.

Setting Threshold τ

Image Content

In one example, the maximum value on input Iⁱ for which the input HDR content is only linearly changed in the output Iₒⁱ is determined based on threshold τ. Optimally, the threshold is large enough to cover more than (100−n) % of the pixels of the content (in one example n=2), and smaller than 100η% of Iₒ^{max} (in one example η=0.8 of the peak output luminance), to prevent clipping very high input luminance values. In one example, for most of natural scenes, very high luminance values contribute to a sparse set of pixels (high dynamic range scene histograms tend to show a highly kurtotic distribution). For such content, the following choice of the threshold tends to leave less than n % of the pixels (in one example n=2) to be compressed into the range of the Iₒ^{max}

τ=η×Iₒ^{max} Equation No. 8-b:

with an example of η=0.8.

For the example of Iₒ^{max}=1500 nits, the threshold τ can be initialized to 1200. This choice of η and n has been experimentally shown to result in subjectively pleasant output images.

In one example, a content-dependent threshold τ is determined as the minimum luminance value. The minimum luminance value is based on a determination that less than n % of the pixels have higher luminance values. In other words, the goal is to find the smallest luminance value that has less than n % of the total pixel numbers lie on its right hand side on the histogram.

In one example, the threshold n (which corresponds to the percentage of the pixels that are going to be non-linearly compressed) is set to 2%. The threshold n allows for the determination of the number of pixels that are being changed. However, in other examples, the value for the threshold n may be set at a percentage that is higher or lower and/or the value for the threshold n may be dependent on the content or application (e.g., display device or content capturing device).

For estimating the content dependent threshold τ (i.e., the knee point in the tone-mapping curve), in a first example, the cumulative histogram of the content is used. The frequency of input luminance I is denoted by h^{I}. The value h^{I} can be determined by calculating the histogram of the input luminance image with any chosen number of bins. The cumulative histogram for value I is denoted by c^{I} and can be found through the following:

c^{I}=Σₛ₌₁^{I}h^{s} Equation No. 9:

In one example, the final threshold may be set equal to the initial value τ_{f}=τ if:

$$100 \frac{{c}^{{I}^{max}} - {c}^{τ}}{{c}^{{I}^{max}}} \leq n \qquad Equation No . 10$$

This condition formulates the case in which there are less than n % of pixels that fall between τ and I^{max} This allows to change more than (100−n) % of the pixels only linearly. If the condition in Equation No. 10 is not satisfied, the breaking point (i.e., the knee point in the tone-mapping curve) is pushed back to increase the range in which the input is compressed.

In one example, the value of ρ is denoted as follows:

$$ρ = 100 \frac{{c}^{{I}^{max}} - {c}^{τ}}{{c}^{{I}^{max}}} , \qquad Equation No . 11$$

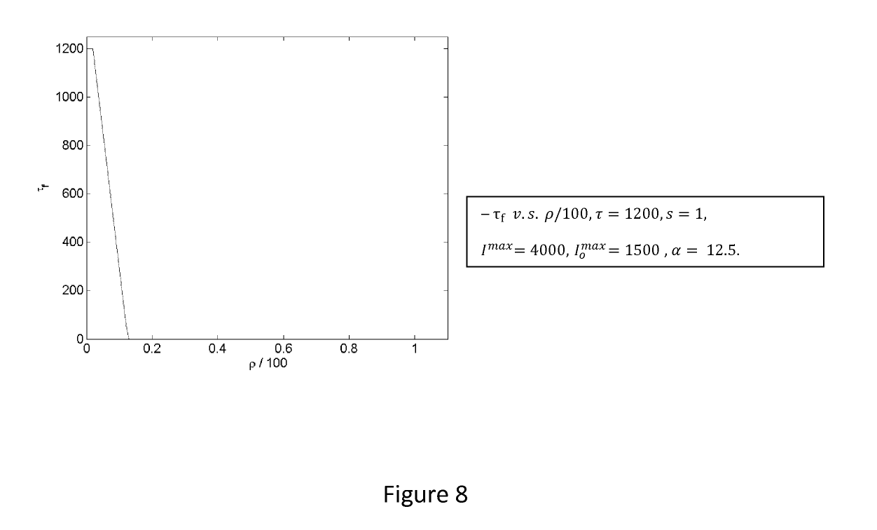

Based on the determination of Equation No. 11, one example of estimating the new value of τ is shown in the following, and consists of linearly reducing τ_{f}

$${τ}_{f} = \{ \begin{matrix}τ & ρ \leq n \\ \frac{{I}_{o}^{max}}{α - n} ( α - ρ ) & n < ρ \leq α \\ 0 & ρ > α\end{matrix} \qquad Equation No . 12$$

where α denotes the maximum percentage of the pixels that can be non-linearly compressed in only a small part of the dynamic range by the tone-mapper [symbol] _{new} (I, τ) without introducing artifacts. One example of such a curve is shown in FIG. 8, for which α=12.5.

As a consequence, for any choice of α, the value for the final threshold τ_{f} for ρ>α is set to 0 (this determination may be performed on an image level, block level, etc.). The value for the final threshold τ_{f} is beneficial because more than α% of the pixels are touched if any threshold larger than 0 is chosen.

A second example for determining the value of the threshold τ is further discussed herein. In one example, the values for c^{I}^{^{max}} and c^{I}^{^{max}}−c^{τ} are required to be estimated. In one example, c^{I}^{^{max}} is equivalent to the number of pixels in the image. In one example, c^{I}^{^{max}}−c^{τ} indicates the number of pixels that have intensities higher than the threshold τ. A fast estimation of c^{I}^{^{max}}−c^{τ} (and consequently ρ) is obtained by counting the number of pixel intensities that are higher than τ. The same estimation of the final threshold τ_{f} is then obtained using Equation No. 12.

In both the first and second examples above, the estimated final threshold τ_{f} is content dependent and smaller than the initial threshold τ. The estimated final threshold τ_{f} prevents the compression of too many pixels into a small range of [τ . . . Iₒ^{max}], and results in a better visual experience.

### Leaky Integration of the Threshold τ for Video Content

For video content, the estimated thresholds for consecutive frames can be different. Noticeable variations in the intensity of consecutive video frames (“flicker”) are not desirable.

An aspect of present principles addresses the problem of flicker by providing a correction of the estimated final threshold τ_{f} values for video frames.

In one example, leaky integration can be applied to obtain the parameter τ_{new}^{t} for a frame t. The parameter τ_{new}^{t} is estimated using τ_{f}^{t} (calculated according to Equation No. 12), and the estimated leaky parameter for the previous frame, i.e., τ_{new}^{t-1}. One example of such estimation is as follows:

τ_{new}^{t}βτ_{f}^{t}+(1−β)τ_{new}^{t-1} Equation No. 13:

The iterative nature of Equation No. 13 implies that for every new next frame, the full history of previous estimations is considered. The user parameter β∈[0 1] controls the smoothness of τ_{new} among the frames.

Color Reconstruction

In one example, luminance values are derived from RGB pixel values according to Equation 1. To reconstruct a tone mapped color image, a simple pixel-wise approach is utilized. The pixel-wise approach scales the RGB values according to the scale change in the luminance channel, as follows:

$$\begin{matrix}{R}_{out}^{i} = {new}_{} ( {I}^{i} , τ ) \frac{{R}^{i}}{{I}^{i}} & Equation No . 14 a \\ {G}_{out}^{i} = {new}_{} ( {I}^{i} , τ ) \frac{{G}^{i}}{{I}^{i}} & Equation No . 14 b \\ {B}_{out}^{i} = {new}_{} ( {I}^{i} , τ ) \frac{{B}^{i}}{{I}^{i}} & Equation No . 14 c\end{matrix}$$

The reconstruction of a color image may also be parameterized by parameter se which controls the amount of saturation, as follows:

$$\begin{matrix}{R}_{out}^{i} = {new}_{} ( {I}^{i} , τ ) {( \frac{{R}^{i}}{{I}^{i}} )}^{se} & Equation No . 15 a \\ {G}_{out}^{i} = {new}_{} ( {I}^{i} , τ ) {( \frac{{G}^{i}}{{I}^{i}} )}^{se} & Equation No . 15 b \\ {B}_{out}^{i} = {new}_{} ( {I}^{i} , τ ) {( \frac{{B}^{i}}{{I}^{i}} )}^{se} & Equation No . 15 c\end{matrix}$$

Meta-Data

In one example, the tone mapping operator could be incorporated into a consumer electronics device such as a set-top box, a television, a monitor, a laptop, a phone, a tablet, a smartphone display, etc. In this case, the tone mapping algorithm may be supplied with meta-data to determine the visual appearance of its output.
The peak luminance of the target display Iₒ^{max} may be supplied by the television/monitor itself. In the case a set-top box is used, this value may be signaled by a connected display device, for example through an HDMI message (see Equation Nos. 3, 6, 7, 8, 12).
The peak luminance of the content I^{max} may be encoded as meta-data alongside the content. It may be provided as a single value per frame, per shot, or per program (television episode, movie, commercial, etc.). In an alternative example, the value of I^{max} may be interpreted as the peak luminance of the display device used (for instance in a post-production house), or the peak luminance of a live camera used in a broadcast scenario (see Equation Nos. 3, 6, 7, 8, 12)
The parameter η, which is used to calculate the threshold τ, may be sent along with the content as meta-data. In an alternative example, the threshold τ, which determines the cross-over between the linear and non-linear parts of the tone mapping curve, may be sent instead (see Eq. 8-b).
The parameter n, which determines the percentage of pixels to be subjected to non-linear compression, may additionally be supplied as meta-data (see Equation Nos. 10, 12).
The parameter α may also be supplied as meta-data (see Equation No. 12).
The parameter β that is used in the leaky integration of the threshold for video content may also be included in the meta-data (see Equation No. 13).

By giving the producer of the content (director of photography, colorist, studio, for example,) control over each of the parameters η (or τ), n, α and β the director's intent can advantageously be better reproduced on a wide variety of displays.

Experimental Results

The algorithm in accordance with present principles (including Equation Nos. 1-14) was tested on HDR images. The HDR images were graded for I^{max}=4000 nits. The target Iₒ^{max} was set to 1500 nits and the slope s was set to 1. The results are viewed on the sim2 displays and subjectively verified. For visualization in this document, the images are scaled linearly and gamma correction of 1/2.2 was applied.

The experimental results demonstrated that the tone mapper [symbol] (I) compresses the full range into the lower dynamic range, therefore losing HDR sensation in both low and high luminance areas, whereas the tone mapper of present principles [symbol] _{new} (I, τ) keeps most of the pixels unchanged and only compresses the very high intensities into the lower range.

The present principles provide a number of advantages. When a high dynamic range frame is passed through the software, a significant portion of all pixels remain completely unchanged (typically all the black and mid-tones), with only the highest values are compressed. In contrast, linear scaling would change all pixel values by the same amount, which all other known tone mapping operators at most leave a small percentage of pixels untouched (typically through the definition of a knee function, which operates exclusively on the darkest values in a frame, the ‘blacks’).

An advantage of present principles is that the amount of range reduction is strictly limited. The intended output device will possess a high peak luminance, albeit lower than the content received. This means that a comparatively gentle reduction in luminance range will suffice. As such, it is possible to design a tone mapping operator that is global in nature, and in fact leaves many pixel values unchanged. The small amount of compression is applied only to the lightest pixels. The advantage of this approach is as follows:
Very low computational complexity
Most pixels are reproduced as intended
A much smaller number of pixels receives some reduction in value, such that contrast loss (and thereby loss of visual quality) is minimized.

The examples described above may be implemented within the figures described below.

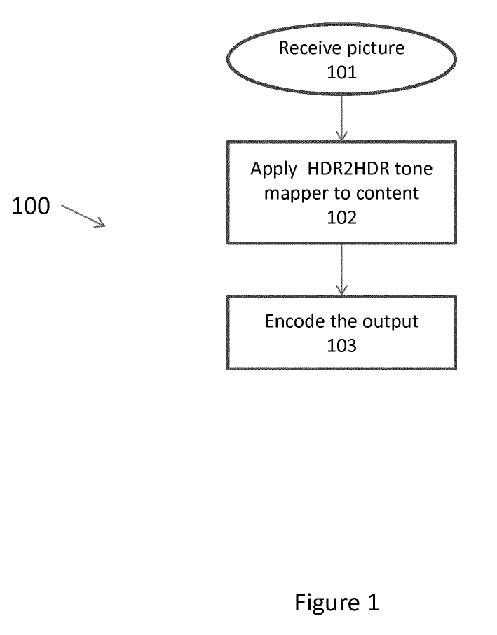

FIG. 1 is a diagram depicting an exemplary method 100 for encoding image or video content in accordance with present principles.

Method 100 may include receiving and encoding a picture. The picture may be encoded into a bit stream using any encoding technique (e.g., HEVC, AVC). Method 100 may be performed in any type of working flow, such as DVB or ATSC standard based distribution workflows, production or authoring workflows, digital video camcorders.

In one example, the method 100 includes receiving a picture at block 101. The picture may be video images or pictures, e.g., for HDR video. Block 101 may receive information regarding the properties of the picture, including linear light RGB information. The picture may be captured using tri-chromatic cameras into RGB color values composed of three components (Red, Green and Blue). The RGB color values depend on the tri-chromatic characteristics (color primaries) of the sensor. The picture may include image side information such as color primaries of the sensor, maximum and minimum luminance peak of the captured scene. Block 101 may then pass control to block 102, including providing any information regarding the received picture.

Block 102 may apply an HDR2HDR tone mapper to the content received from block 101. The HDR2HDR tone mapper may be determined in accordance with present principles. The HDR2HDR tone mapper converts the dynamic range of the content to fit into the dynamic range of the display.

The HDR2HDR tone mapper is applied in accordance with principles described in connection with the present invention. The use case of the present invention provides the advantage of reducing the range of luminance values by a very large amount. Application of the HDR2HDR tone mapper in accordance with present principles results in a limited the amount of range reduction. The intended output device will possess a high peak luminance, albeit lower than the content received. This means that a comparatively gentle reduction in luminance range will suffice. As such, it is possible to design a tone mapping operator that is global in nature, and in fact leaves many pixel values unchanged. The small amount of compression is applied only to the lightest pixels. The advantage of this approach is as follows:
Very low computational complexity
Most pixels are reproduced as intended
A much smaller number of pixels receives some reduction in value, such that contrast loss (and thereby loss of visual quality) is minimized.

The HDR2HDR tone mapper includes one or more of the following:
1—It contains a linear part for the dark and mid-tone levels, and a nonlinear compressive part for the highlights, such as for example, the information outlined in Equation No. 2
2—The design of the tone mapping curve forcing criteria to obtain a C1 function. As used herein, a “C1” function is defined as a function with its first derivative being defined and continuous everywhere in the open interval of the input of the derivative function domain. See for example, Equation Nos. 3-8
3—The content-based estimation of the knee point. See for example, Equation Nos. 9-13. For example, the HDR2HDR tone mapper is designed in accordance with present principles including a linear curve with a small compression range, the design of the curve to match smoothness criteria, and the estimation of a curve threshold based on content.

Block 103 may encode the output of block 102. Block 103 may encode the output in accordance with any existing encoding/decoding standard. For example, block 103 may encode in accordance with the High Efficiency Video Coding (HEVC) standard organized by the International Telecommunication (ITU) and the organization Moving Picture Experts Group (MPEG). Alternatively, the block 103 may encode in accordance with the H.264 or MPEG-4 Part 10, Advanced Video Coding (MPEG-4 AVC) organized by the International Organization for Standardization/International Electrotechnical Commission (ISO/IEC) Moving Picture Experts Group-4 (MPEG-4). Alternatively, the block 103 may encode with any other known encoding techniques.

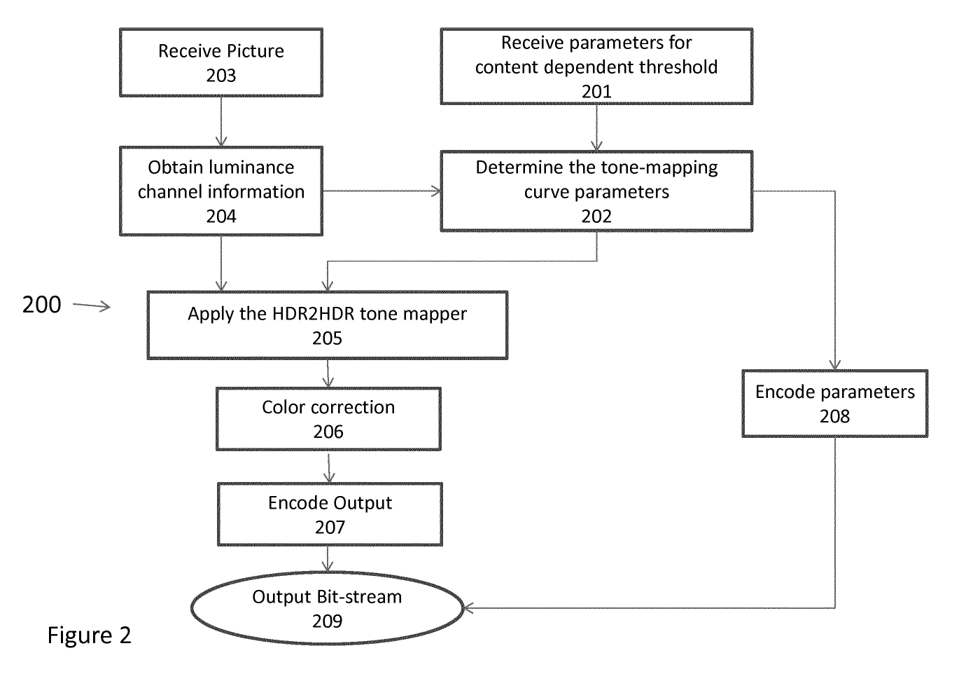

FIG. 2 is a diagram depicting an exemplary method 200 for encoding a picture and parameters. Method 200 includes a block 201 for receiving parameters for content dependent threshold. The parameters received may be the peak luminance of the target display Iₒ^{max} (see, e.g., Equation Nos. 3, 6, 7, 8, 12), the peak luminance of the content I^{max} (see, e.g., Equation Nos. 3, 6, 7, 8, 12), the parameter η, which is used to calculate the threshold τ (see, e.g., Equation No. 8-b), the parameter n, which determines the percentage of pixels to be subjected to non-linear compression (see, e.g., Equation Nos. 10, 12), the parameter α which determines the maximum percentage of the pixels that can be compressed in only a small part of the dynamic range by the tone-mapper (see, e.g., Equation No. 12), and the parameter β that is used in the leaky integration of the threshold for video content (see, e.g., Equation No. 13). The parameters received at block 201 are utilized for estimating content dependent threshold in accordance with the principles described in connection with Equation No. 8-b, and Equation Nos. 9-13.

Block 202 may determine the tone-mapping curve parameters. Block 202 may determine the parameters a,c,d. The tone-mapping curve parameters may be determined based on criteria that enforces the tone-mapping curve to be a C1 function (i.e., a function with its first derivative being defined and continuous everywhere in the open interval of the input as the derivative function domain) in accordance with Equation Nos. 3-8. Block 208 may encode the parameters determined by block 202.

Block 203 may receive a picture. In one example, block 203 may receive a picture in accordance with principles outlined in connection with block 101 of FIG. 1.

Block 204 may obtain luminance channel information of the received picture. In one example, block 204 may apply a preliminary color transform to obtain luminance channel information of the received picture. In one example, block 204 may apply a preliminary color transform to obtain the luminance channel information. In one example, block 204 may determine luminance channel information in accordance with principles described in connection with Equation No. 1. In another example, block 204 may be optional and luminance information may be directly received from block 203.

Block 205 may apply the HDR2HDR tone mapper. In one example, block 205 may apply the HDR2HDR tone mapper in accordance with principles described in connection with block 102 of FIG. 1. In one example, block 205 may apply the HDR2HDR tone mapper to get an output Iₒ.

Block 206 may perform color correction on the output of block 205. For example, block 206 may perform color correction by scaling the RGB values according to the scale change in the luminance channel in accordance with Equation Nos. 14-a to 15-c. Block 206 may output a color corrected output.

Block 207 may encode the output of block 206.

Block 209 may output into the outstream the parameters encoded by block 208 and the output encoded by block 207.

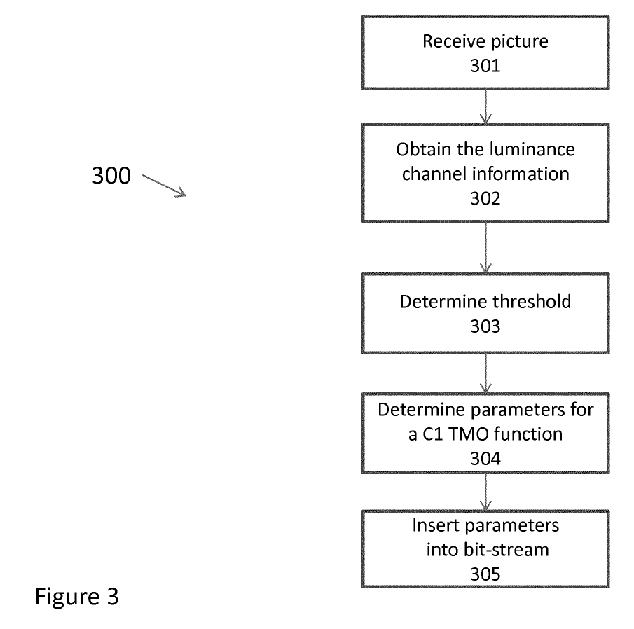

FIG. 3 is a diagram depicting an exemplary method 300 for determining and encoding the parameters for the tone mapper. The method 300 may encode the parameters for the knee point τ_{f} (which may be determined in accordance with principles described in connection with Equation No. 12), and the curve parameters a,c,d (which may be determined in accordance with principles described in connection with Equation Nos. 6-8).

Block 301 may receive a picture, which may be an image or a frame of a video.

Block 302 may perform a preliminary color transform to obtain the luminance channel information. In one example, block 302 may perform a preliminary color transform in accordance with principles described in connection with Equation No. 1. Alternatively, block 302 may be optional and luminance channel information may be received from block 301.

Block 303 may determine the threshold of the tone mapper algorithm. In one example, block 303 may determine the threshold that defines the knee point in the tone-mapping curve (which may be determined in accordance with principles described in connection with Equation Nos. 2-8). Block 303 may determine the maximum value on input luminance for which the input HDR content is only linearly changed in the output. A content-dependent threshold is estimated as the minimum luminance value, compared to which less than an a priori-fixed percentage of the pixels have higher luminance values. Two methods are provided as examples to the estimation of this content dependent threshold as described above in connection with the Section ‘ Setting threshold τ’. In one example, block 303 may determine the threshold based on the cumulative histogram of the content. Denoting the cumulative histogram for value I by c^{I}, the following condition is verified:

$$100 \frac{{c}^{{I}^{max}} - {c}^{τ}}{{c}^{{I}^{max}}} \leq n ,$$

where n denotes the percentage of the pixels that are allowed to be compressed by the non-linear part of the tone-mapping curve. If this conditioned is satisfied, the initial value of the 80% of the maximum luminance of the target display is considered as the knee point. If not, the threshold is obtained using Equation No. 12. This example is formalized through Equation Nos. 9-12. In another example, the input luminance image is thresholded by the initial value of the 80% of the maximum luminance of the target display, and the number of pixels that have values bigger than the threshold is counted as well as the total number of pixels. Equation Nos. 11-12 are then used to estimate the final knee point of the tone-mapping curve.

Block 304 may estimate parameters for a C1 tone mapping operator (“TMO”) function. In particular, the tone-mapper needs to be continuous, its derivative needs to be continuous, and the maximum output need to be mapped to the maximum luminance of the output display. These criteria are formalized in Equation Nos. 3-5 and the consequently estimated parameters of the curve are obtained in Equation Nos. 6-8. The outputs of block 304 are the threshold τ_{f}, and the curve parameters a,b,c.

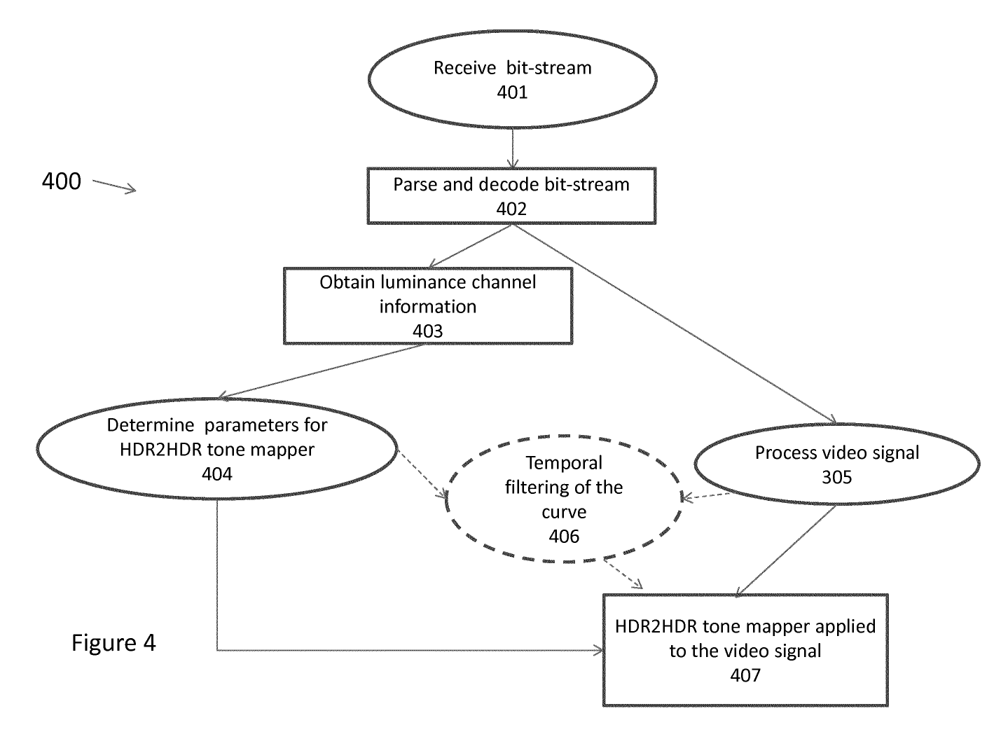

FIG. 4 is a diagram depicting an exemplary method 400 for decoding a picture or video in accordance with present principles.

Block 401 may receive a bit-stream corresponding to a video or image sequence. The received bit-stream has been encoded (e.g., using AVC, HEVC, etc. encoding). Block 401 may then pass control to block 402.

Block 402 may parse and decode the bit-stream received from block 301. In one example, the block 402 may parse and decode the bit-stream using HEVC based decoding. Block 402 may then pass control to block 403.

Block 403 may obtain luminance channel information. In one example, block 403 may be optional. In one example, block 403 may obtain luminance channel information in accordance with principles described in connection with Equation No. 1. Block 403 may then pass control to blocks 404 and 405.

Block 404 may determine the parameters for the HDR2HDR tone mapper in accordance with present principles. The parameters may be any parameters discussed herewith in accordance with present principles. In one example, the parameters are determined based off of syntax contained in the bit-stream (e.g., an SEI message). The parameters may be the threshold τ_{f}, and the curve parameters a,b,c. These parameters can be transmitted through the bitstream, or they can also be determined at the decoder. These parameters are estimated in one example from the histogram of the luminance information.

Block 405 may process a video signal. In one example, block 504 may process a decoded Y′CbCr video signal. In one example, block 504 may convert a Y′CbCr video signal to a R′G′B′ video signal. In another example, block 504 may process a R′G′B′ video signal.

Block 406 may perform temporal filtering of the curve. For video content, the estimated thresholds for consecutive frames can be different. Considering the fact that flicker (i.e., noticeable variations in the intensity of the consecutive frames) is not desired for the video content, a correction of the estimated τ_{f} values for every new frame of the video is proposed.

In particular, a standard technique called leaky integration can be applied to the parameter τ_{new}^{t} for frame t, which is estimated using τ_{f}^{t} calculated as shown in the previous section, and the estimated leaky parameter for the previous frame, i.e., τ_{new}^{t-1}, In one example, this may be performed in accordance with principles described in connection with Equation No. 13. The input of block 406 is the luminance channel information from block 305 and the final threshold of the previous frame. The curve in block 406 corresponds to the tone-mapping curve. Block 306 is optional but strongly recommended to remove possible source of flicker in the output video. The output of the Block 306 is the leaky estimation of the threshold and the updated parameters of the tone-mapping curve using the principles described in connection with Equation Nos. 6-8 and 13.

Block 407 may apply the HDR2HDR tone mapper to the video signal. It is performed frame by frame using the corresponding estimated parameters. In one example block 407 may apply the HDR2HDR tone mapper in accordance with principles described in connection with blocks 102 and 205. In one example, block 307 may create a Look Up Table (LUT) with tabulated values (e.g., based on Eqn. Nos. 12-13) and then applying the LUT on the content to be mapped/demapped.

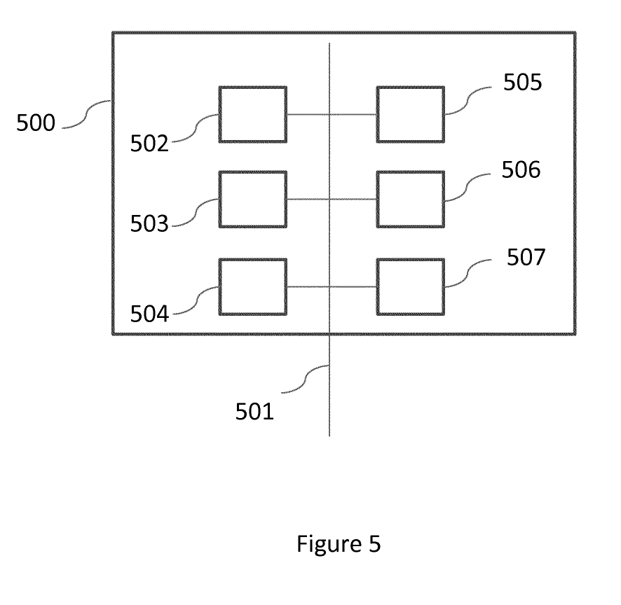

FIG. 5 represents an exemplary architecture of a device 500 which may be configured to implement methods described in relation with FIGS. 1-4 and Equation Nos. 1-13. In one example, FIG. 5 represents an apparatus that may be configured to implement the encoding method according to present principles, including principles described in relation to FIGS. 1-34. In one example, FIG. 5 represents an apparatus that may be configured to implement the decoding method according to present principles, including principles described in relation to FIG. 4.

Device 500 comprises following elements that are linked together by a data and address bus 501:
a microprocessor 502 (or CPU), which is, for example, a DSP (or Digital Signal Processor);
a ROM (or Read Only Memory) 503;
a RAM (or Random Access Memory) 504;
an I/O interface 505 for reception of data to transmit, from an application; and
a battery 506 (or other suitable power source).

According to a variant, the battery 506 is external to the device. In each of mentioned memory, the word « register » used in the specification can correspond to area of small capacity (some bits) or to very large area (e.g. a whole program or large amount of received or decoded data). ROM 503 comprises at least a program and parameters. Algorithm of the methods according to the invention is stored in the ROM 503. When switched on, the CPU 502 uploads the program in the RAM and executes the corresponding instructions.

RAM 504 comprises, in a register, the program executed by the CPU 502 and uploaded after switch on of the device 500, input data in a register, intermediate data in different states of the method in a register, and other variables used for the execution of the method in a register.

The implementations described herein may be implemented in, for example, a method or a process, an apparatus, a software program, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

According to a specific example of encoding or encoder, the image or picture I is obtained from a source. For example, the source belongs to a set comprising:
a local memory (503 or 504), e.g. a video memory or a RAM (or Random Access Memory), a flash memory, a ROM (or Read Only Memory), a hard disk;
a storage interface (505), e.g. an interface with a mass storage, a RAM, a flash memory, a ROM, an optical disc or a magnetic support;
a communication interface (505), e.g. a wireline interface (for example a bus interface, a wide area network interface, a local area network interface) or a wireless interface (such as a IEEE 802.11 interface or a Bluetooth® interface); and
an image capturing circuit (e.g. a sensor such as, for example, a CCD (or Charge-Coupled Device) or CMOS (or Complementary Metal-Oxide-Semiconductor)).

According to different embodiments of the decoding or decoder, the decoded image Î is sent to a destination; specifically, the destination belongs to a set comprising:
a local memory (503 or 504), e.g. a video memory or a RAM, a flash memory, a hard disk;
a storage interface (505), e.g. an interface with a mass storage, a RAM, a flash memory, a ROM, an optical disc or a magnetic support;
a communication interface (505), e.g. a wireline interface (for example a bus interface (e.g. USB (or Universal Serial Bus)), a wide area network interface, a local area network interface, a HDMI (High Definition Multimedia Interface) interface) or a wireless interface (such as a IEEE 802.11 interface, Wi-Fi® or a Bluetooth® interface); and
a display.

According to different examples of encoding or encoder, the bitstream BF and/or F are sent to a destination. As an example, one of bitstream F and BF or both bitstreams F and BF are stored in a local or remote memory, e.g. a video memory (504) or a RAM (504), a hard disk (503). In a variant, one or both bitstreams are sent to a storage interface (505), e.g. an interface with a mass storage, a flash memory, ROM, an optical disc or a magnetic support and/or transmitted over a communication interface (505), e.g. an interface to a point to point link, a communication bus, a point to multipoint link or a broadcast network.

According to different examples of decoding or decoder, the bitstream BF and/or F is obtained from a source. Exemplarily, the bitstream is read from a local memory, e.g. a video memory (504), a RAM (504), a ROM (503), a flash memory (503) or a hard disk (503). In a variant, the bitstream is received from a storage interface (505), e.g. an interface with a mass storage, a RAM, a ROM, a flash memory, an optical disc or a magnetic support and/or received from a communication interface (505), e.g. an interface to a point to point link, a bus, a point to multipoint link or a broadcast network.

According to different examples, device 500 being configured to implement an encoding method in accordance with present principles, belongs to a set comprising:
a mobile device;
a communication device;
a game device;
a tablet (or tablet computer);
a laptop;
a still image camera;
a video camera;
an encoding chip;
a still image server; and
a video server (e.g. a broadcast server, a video-on-demand server or a web server).

According to different examples, device 500 being configured to implement a decoding method in accordance with present principles, belongs to a set comprising:
a mobile device;
a communication device;
a game device;
a set top box;
a TV set;
a tablet (or tablet computer);
a laptop;
a display and
a decoding chip.

Implementations of the various processes and features described herein may be embodied in a variety of different equipment or applications. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described example, or to carry as data the actual syntax-values written by a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

Numerous specific details have been set forth herein to provide a thorough understanding of the present invention. It will be understood by those skilled in the art, however, that the examples above may be practiced without these specific details. In other instances, well-known operations, components and circuits have not been described in detail so as not to obscure the present invention. It can be appreciated that the specific structural and functional details disclosed herein may be representative and do not necessarily limit the scope of the present invention.

Various examples of the present invention may be implemented using hardware elements, software elements, or a combination of both. Some examples may be implemented, for example, using a computer-readable medium or article which may store an instruction or a set of instructions that, if executed by a machine, may cause the machine to perform a method and/or operations in accordance with the examples. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus and constituents included therein, for example, a processor, an encoder and a decoder, may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, processing the information, transmitting the information, moving the information, copying the information, erasing the information, calculating the information, determining the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

According to different embodiments, the parameterized transfer function is signaled in the picture encoded or decoded according to the invention, or in a stream including the picture. In some embodiments, an information representative of the parameterize transfer function is signaled in the picture or in the stream including the picture. This information is used by a decoding method or decoder to identify the parameterized transfer function that is applied according to the invention. In one embodiment, this information includes an identifier that is known on encoding and decoding side. According to other embodiments, this information includes parameters used as a basis for parameterized transfer functions. According to a variant of the invention, this information comprises an indicator of the parameters in the picture or in a bit-stream including the picture, based on a set of defined values. According to a variant of the invention, this information comprises an indication based on whether the parameters are signaled explicitly or whether the parameters are signaled implicitly based on a set of defined values. According to different variants of the invention, this information is included in at least one syntax element included in at least one of a Picture Parameter Set (PPS), a Sequence Parameter Set (SPS), a Supplemental Enhancement Information (SEI) message, a Video Usability Information (VUI), Consumer Electronics Association (CEA) message, and a header.

The invention also concerns apparatus for encoding and for decoding adapted to perform respectively the above methods of encoding and decoding.

1. A method for tone mapping a high dynamic range image, the method comprising
obtaining a luminance component of the high dynamic range image;
determining an hdr-to-hdr tone mapper curve;
determining a tone compressed image by applying the hdr-to-hdr tone mapper curve to the luminance component of the high dynamic range image;
wherein the hdr-to-hdr tone mapper curve comprises a linear part for dark and mid-tone levels, and a compressive non-linear part for highlights.

2. An apparatus for tone mapping a high dynamic range image, the apparatus comprising
a processor for obtaining a luminance component of the high dynamic range image, determining an hdr-to-hdr tone mapper curve, and determining a tone compressed image by applying the hdr-to-hdr tone mapper curve to the luminance component of the high dynamic range image;
wherein the hdr-to-hdr tone mapper curve comprises a linear part for dark and mid-tone levels, and a compressive non-linear part for highlights.

3. The method of claim 1, wherein the hdr-to-hdr tone mapper includes a threshold for determining when the luminance is changed linearly and when the luminance is compressed non-linearly.

4. The method of claim 1, wherein a final threshold τ_{f} is determined based on an initial threshold τ according to the following equation:
$${τ}_{f} = \{ \begin{matrix}τ & ρ \leq n \\ \frac{τ}{α - n} ( α - ρ ) & n < ρ \leq α \\ 0 & ρ > α\end{matrix}$$
where Iₒ^{max} is a maximum luminance value for the tone compressed image, n is the percentage of pixels in the image that corresponds to highlights, α denotes the maximum percentage of the pixels that can be non-linearly compressed in only a small part of the dynamic range by the tone-mapper without introducing artifacts in the tone compressed image, and where
$$ρ = 100 \frac{{c}^{{I}^{max}} - {c}^{τ}}{{c}^{{I}^{max}}} ,$$
where c^{I}^{^{max}} and c^{τ} denote the cumulative histogram for respectively the maximum luminance component I^{max} of the image and a luminance corresponding to the initial threshold τ.

5. The method of claim 1, further comprising determining the threshold based on content of said high dynamic range image.

6. The method of claim 1, further comprising criteria to enforce continuity and smoothness of the hdr-to-hdr tone-mapper curve.

7. The method of claim 1,
wherein the high dynamic range image is part of a high dynamic range video, and
wherein the application of the hdr-to-hdr tone mapper curve includes applying information from prior video frames to achieve temporal stability.

8. The method of claim 7, wherein the information from prior video frames is applied using leaky integration based on the threshold.

9. The method of claim 1, further comprising signaling information representative of the hdr-to-hdr tone mapper curve.

10. The method of claim 8, wherein the signaling is performed using at least one syntax element included in at least one of a Picture Parameter Set (PPS), a Sequence Parameter Set (SPS), a Supplemental Enhancement Information (SEI) message, a Video Usability Information (VUI), Consumer Electronics Association (CEA) message, and a header.

11. The method of claim 1, wherein parameters of the hdr-to-hdr tone mapper curve are modulated as a function of the threshold, and wherein the parameters are modulated at least one selected from a group of linearly and non-linearly.

12. A method for tone mapping a high dynamic range image, the method comprising
obtaining a luminance component of the high dynamic range image;
determining an hdr-to-hdr tone mapper curve;
determining a tone compressed image by applying the hdr-to-hdr tone mapper curve to the luminance component of the high dynamic range image;
wherein the hdr-to-hdr tone mapper curve is multi-segmented, and
wherein the multi-segmented curve includes at least a segment that is not linear and at least a segment that is linear.

13. The method of claim 12,
wherein the linear segment is directed to at least one selected from a group of darks, mid-tones, and highlights,
and wherein the non-linear segment is directed to at least one selected from a group of darks, mid-tones, and highlights.

14. A computer program product comprising program code instructions to execute the steps of the method according to claim 1, when this program is executed by a processor.

15. The apparatus of claim 2, wherein the hdr-to-hdr tone mapper includes a threshold for determining when the luminance is changed linearly and when the luminance is compressed non-linearly.

16. The apparatus of claim 2, further comprising determining the threshold based on content of said high dynamic range image.

17. The apparatus of claim 2, further comprising criteria to enforce continuity and smoothness of the hdr-to-hdr tone-mapper curve.

18. The apparatus of claim 2,
wherein the high dynamic range image is part of a high dynamic range video, and
wherein the application of the hdr-to-hdr tone mapper curve includes applying information from prior video frames to achieve temporal stability.

19. The apparatus of claim 2, further comprising signaling information representative of the hdr-to-hdr tone mapper curve.

20. The apparatus of claim 2, wherein parameters of the hdr-to-hdr tone mapper curve are modulated as a function of the threshold, and wherein the parameters are modulated at least one selected from a group of linearly and non-linearly.
